(19) United States
(12) Patent Application Publication
(10) Pub. No.: US 2006/0035508 A1
(43) Pub. Date: Feb. 16, 2006

(54) PROTECTIVE DEVICE OF EXTENSION CORD

(76) Inventor: Albert Stekelenburg, Taipei (TW)

Correspondence Address: BRUCE H. TROXELL;SUITE 1404, 5205 LEESBURG PIKE, FALLS CHURCH, VA, 22041, US

(21) Appl. No.: 10/915,545

(22) Filed: Aug. 11, 2004

(51) Int. Cl. H01R 13/62

(52) U.S. Cl. 439/369

(57) ABSTRACT

A protective device of extension cord comprises a male component and a female component. Said male component is provided in the conductive wire having a connector A and the female component is provided in the conductive wire having a connector B. When connector A combines with connector B, male component interlocks with component B and provides the protection of the position which connector A connecting with connector B.

### FIELD OF THE INVENTION

The present invention is relating to a protective device which used in the combination of extension cord, especially to a protective device used in the combination of extension cord or relating electrical as well as communication wire or cable.

### BACKGROUND OF THE INVENTION

In modern world, people keep increasing the utility of electrical facility, computer, communicating instrument and control system. These electrical facility and system use a lot of versatile electrical wire, cable line, data transmission line etc. During the use, the line always is insufficient in length and need the extension cord to lengthen the distance of power supply and signal transmission.

The combination or connection of line connection or joint of conventional extension cord, always loose caused by the pulling the line by external force; furthermore, the position of connectors may be pressed or get wet by water and become dangerous.

To solve the above-mention problem, there are many different solution had been provided. As shown in FIG. 1, it is a box having an inner space A which positioning the joint (connector) of electrical line (wire) B and C (the end portions are D & E). This kind of box only can be used in some specified products and the dimension is large and certain space is needed.

### SUMMARY OF THE INVENTION

The purpose of the present invention is to provide a structure of solving the above-mentioned problem, by providing a protective device in every wire connector of the extension cord. That is, providing a male component in the joint of an electrical wire and a female component in the joint of another electrical wire. Thereby, after combination of both joints, the male component also combines with the female component to form a device having an inner protective space.

The second purpose of the present invention is to provide a preset component on line joint. Said component can be divided to a male component and a female component preset on the predetermined joints for backup use.

Furthermore, by the technology of the present invention, the male and female component can be the same structures and locked respectively.

### BRIEF DESCRIPTION OF DRAWINGS

FIG. 1 is the perspective view of a prior art.

FIG. 2 is the perspective view of the embodiment of the present invention.

FIG. 3 is the sectional view of the embodiment of the present invention.

FIG. 4 is the perspective view of the embodiment of the present invention in combination status.

FIG. 5 is the perspective view of an embodiment of the present invention in practical use.

FIG. 6 is the perspective view of another embodiment of the present invention in practical use.

FIG. 7 is the perspective view of another one embodiment of the present invention in practical use.

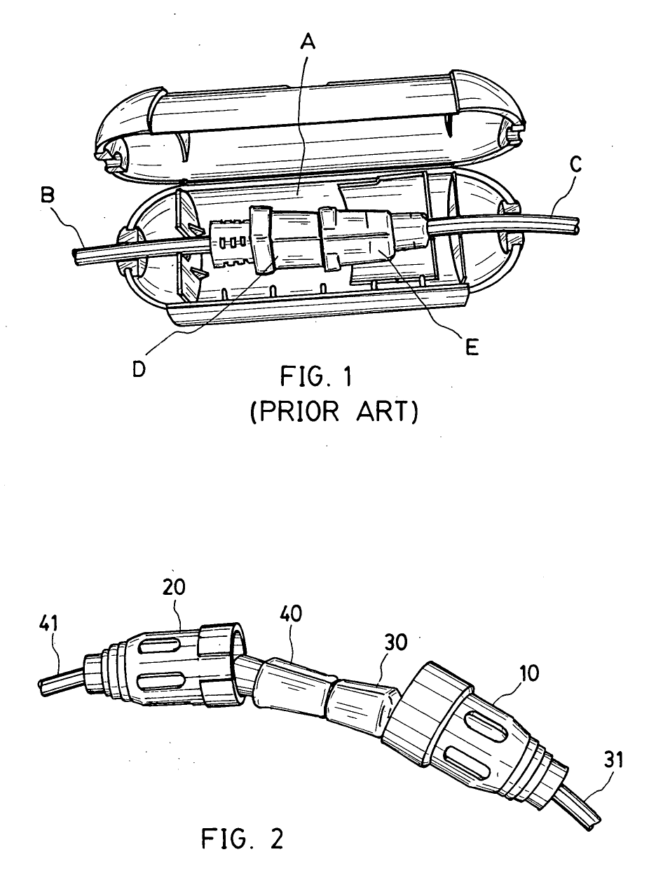

### DETAILED DESCRIPTION OF THE PREFERRED EMBODIMENTS

Referring to FIG. 2, 3 and 4, the present invention includes a male component 10, a female component 20. Said male component 10 is provided in the conductive wire 30 of the position of connector A 30, and the female component is provided in the conductive wire 40 of the position of connector B 40.

Connector A 30 is an end portion of the conductive wire 31 for combining connector B 40.

Connector B 40 is an end portion of the conductive wire 41 for combining connector A 30.

Connector A 30 and connector B 40 are convention joints and can be in different types which enable to transmit the electricity or signal after connection.

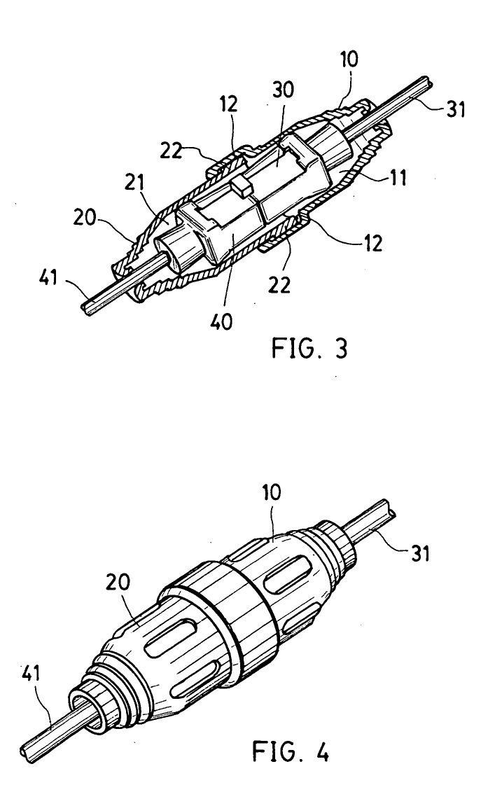

As shown on FIG. 3, male component 10 comprising a space 11, a snap slot 12 and said space 11 is able to receive the preset connector A 30 and further providing the conductive wire 31 extension through. The female component includes a space 21, a snap component 22 and said space can receive the preset connector B 40 and further providing the conductive line wire extension through. Said snap component 22 and said snap slot 12 can be combined and connected by turning and make the male component 10 and female component 20 stably combine together. Furthermore, the combined snap component 22 and snap slot 12 also can be separated by turning and make the male component 10 and female component 20 separate.

FIG. 4 shows the perspective view of the assembly of the embodiment. Under the locking status of male component 10 and female component 20, the inner component can be protected and in normal operation.

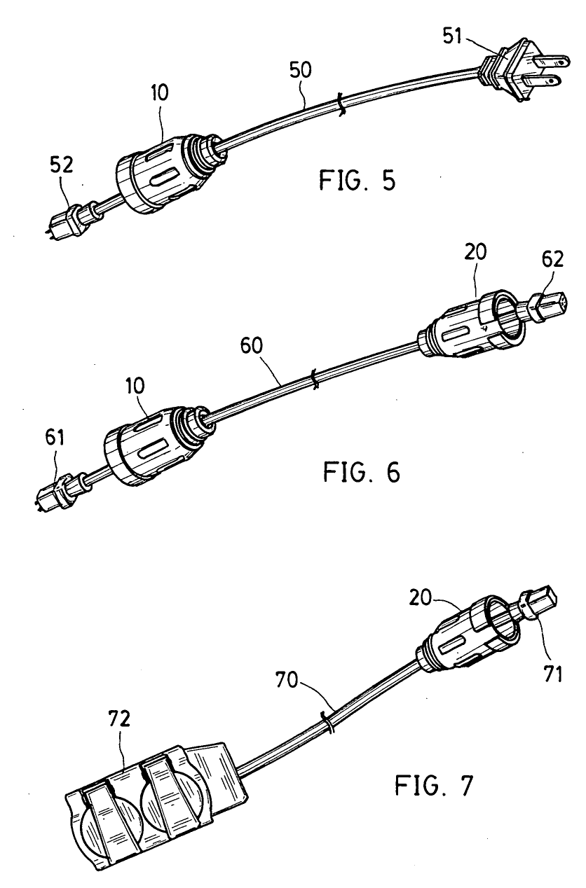

As shown in FIG. 5, a male component preset in a conductive wire 50 and the conductive wire having a plug 51 one end and one connector A 52 other end. Then, plug 51 can be replaced by different plug or relating component and connector 52 can be ready to combine with the corresponding connector B.

As shown in FIG. 6, a male component 10 and a female component preset in each end of conductive wire respectively, the position of both ends can separately preset connector A 61 and connector B 62.

As shown in FIG. 7, a female component 20 preset in a conductive wire, and the ends of the wire preset a connector B 70 and a socket 72 respectively. Said socket can be different kinds of sockets or relating electrical appliance of facility.

The above-mentioned male component 10 and female component 20 are interchangeable. That means, the male component 10 is not limited to conform to connector A 30 nor female component 20 must conform to connector B 40.

The embodiments shown in FIG. 4, 5 and 6 can be merchandised as product and offer for sale and use.

In the sum, the present invention is relating to the protective device of extension cord. By conform the type of connector, after the connection of connectors, enable the locking of the male component and female component. By the way, to form the protection in the position connectors combined.

Furthermore, said male component 10 and female component 20 can be designed in the same structure and can be locked respectively by each other. The purpose is to provide a protective space after interlocking, and said space can receive the wire and the combined of wires.

1-5. (canceled)

6. A protective device for an extension cord comprising:
a) a male component having:
i) a first conductive wire;
ii) a connector A connected to a first end of the first conductive wire and being selectively inserted into an interior of the male component; and
iii) a snap slot located on an interior of a peripheral surface of the male component; and
b) a female component having:
i) a second conductive wire;
ii) a connector B connected to a first end of the second conductive wire and being selectively inserted into an interior of the female component, the connector A being selectively connected to connector B; and
iii) a snap component located on an exterior of a peripheral surface of the female component, the snap component being movable between locked and unlocked positions by rotating the snap component relative to the snap slot when the snap slot of the female component is inserted into the male component, the snap component and the snap slot are concealed in the locked position.

7. The protective device according to claim 6, wherein the first conductive wire having a first plug located on a second end of thereof, and the second conductive wire having a second plug located on a second end of thereof.
